(19) United States
(12) Patent Application Publication
(10) Pub. No.: US 2004/0251406 A1
(43) Pub. Date: Dec. 16, 2004

(54) Micro-sized tilt sensor

(76) Inventor: Robert Figueria, San Jose, CA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/462,466

(22) Filed: Jun. 16, 2003

(51) Int. Cl. G01D 5/34

(52) U.S. Cl. 250/231.1

(57) ABSTRACT

A tilt sensor especially adapted for micro-size, which includes a micro-size housing with a cavity inside. An element, such as a disk, is movable in the cavity between a default position and a second position. A light source is aligned with an aperture which, in turn, is aligned with the default position of the disk in the cavity. In the default position the disk blocks the light source. If the housing is tipped sufficiently in a certain plane, the disk moves out of the default position allowing light from the light source to enter the cavity. A photo detector aperture is positioned to receive light from the unblocked light source to indicate tilt of the housing. The housing can be made of two pieces and plastic and receive a printed circuit board with all electrical optical components.

### BACKGROUND OF THE INVENTION

1. Field of the Invention

The present invention relates to a sensor for sensing rotational movement, and in particular, a tilt sensor that can be adapted to indicate tilt in at least one direction in a plane.

2. Problems in the Art

Tilt sensors (sometimes called inclinometers) sense rotational movement of the sensor or the body to which they are attached. Many times they actuate or produce a signal in response to rotation in the plane. A variety of uses exist for such tilt sensors.

Co-pending, co-owned U.S. Ser. No. 10/210,170, filed Aug. 1, 2002, discloses embodiments of tilt sensors of this type.

Such tilt sensors can be used to create an alert or alarm perceivable by the user, or to initiate some action. The alarm or action can be autonomous.

U.S. Ser. No. 10/210,170 illustrates a relatively small tilt sensor that can be placed inside or on an object (e.g. camera). It can actuate an alarm for the user if the camera is tilted beyond an angular amount in either direction generally a vertical plane. Gravity works on a member inside of a race. Depending on direction of tilt, the member occludes a photo detector. Appropriate circuitry interprets the state of the photo detector to interpret whether tilt necessitating an alarm has occurred.

While the tilt sensor of Ser. No. 10/210,170 provides certain advantages, there is still room for improvement in the art. For example, cameras, and particularly digital cameras, are being made smaller and smaller. Miniaturization of the camera itself means there is less room for auxiliary components such as a tilt sensor.

### BRIEF SUMMARY OF THE INVENTION

It is therefore a principal object of the present invention to provide an apparatus and method which improves upon or solves problems and deficiencies in the art.

Another object, feature, advantage or aspect of the present invention is to provide an apparatus and method which accurately senses rotation in a plane.

Still other objects, features, advantages, and aspects of the present invention include an apparatus and method which:

a) senses tilt in one or more directions in a plane;

b) uses reflectivity principals with electro-optical principals;

c) enables manufacturing to small sizes, even miniaturization and micro-sizes;

d) is reliable;

e) is durable; and

f) is economical.

According to one aspect of the invention, an apparatus includes a housing having a cavity. The cavity is adapted to form a race for a movable disk. The disk can move between at least a first default position and a second position. An electromagnetic radiation source is mountable on the housing and adapted to transmit light through an aperture coincident with the default position of the cavity. A photo detector is mountable to the housing and adapted to receive light energy through an aperture coincident with the second position in the cavity. When the body is in a reference or default position (generally horizontal in use), the disk by gravity is seated in the default position and blocks the aperture to the light source. When the body is rotated in generally vertical plane, gravity causes the disk to move away from the default position. Light energy from the light source is allowed to enter through the coincident aperture into the cavity. The interior of the cavity has least some reflectivity properties. A photo detector, appropriately positioned away from the second position for the disk, would then receive reflected light energy to indicate tilt from the default position.

In another aspect of the invention, the cavity can have a third position, like the second position, away from the default position. The third position can indicate a different direction on state of tilt.

In a still further aspect of the invention, the apparatus can be micro-sized where the disk is on the order of one or two millimeters diameter or less. The housing can be molded from plastic in two pieces.

In a still further aspect of the invention, the disk cavity can be configured for a variety of sensing functions, including threshold amounts of tilt before the disk moves out of the default position.

### BRIEF DESCRIPTION OF THE DRAWINGS

FIG. 1 is an enlarged sectional assembled view of a tilt sensor according to an exemplary embodiment of the present invention.

FIG. 2 is an isolated front elevation view of a printed circuit board that can be assembled into one side of the tilt sensor of FIG. 1.

FIG. 3 is a back elevation of the tilt sensor of FIG. 1 with the back housing lid removed and the sensor in a reference or default position relative to horizontal.

FIG. 4A is an interior elevation of a housing lid for the tilt sensor of FIG. 1.

FIG. 4B is a sectional view taken along FIG. 4B of FIG. 4A.

FIG. 5A is a diagrammatic perspective view of the tilt sensor of FIG. 1 mounted to the interior side of the back wall of a digital camera and in the reference or default position relative to horizontal, indicated by the X axis.

FIG. 5B is a top sectional diagrammatic view of FIG. 5A.

FIGS. 6A and 6B are similar to FIGS. 5A and 5B except showing the tilt sensor rotated such that its left side is tilted below generally horizontal.

FIGS. 7A and 7B are similar to FIGS. 5A and 5B except showing the right side of the tilt sensor rotated below horizontal.

FIGS. 8A and 8B are perspective views relative to the coordinate system of FIGS. 5-7, but showing the tilt sensor tilted forwardly and downwardly around the X axis.

### DETAILED DESCRIPTION OF THE PREFERRED EMBODIMENT

For a better understanding of the invention, one illustrative embodiment the invention can take will now be described in detail. Reference will be taken to the drawings. Reference numerals will be used to indicate certain parts and locations in the drawings. The same reference numerals will be used to indicate the same parts and locations throughout the drawings, unless otherwise indicated.

A. Apparatus

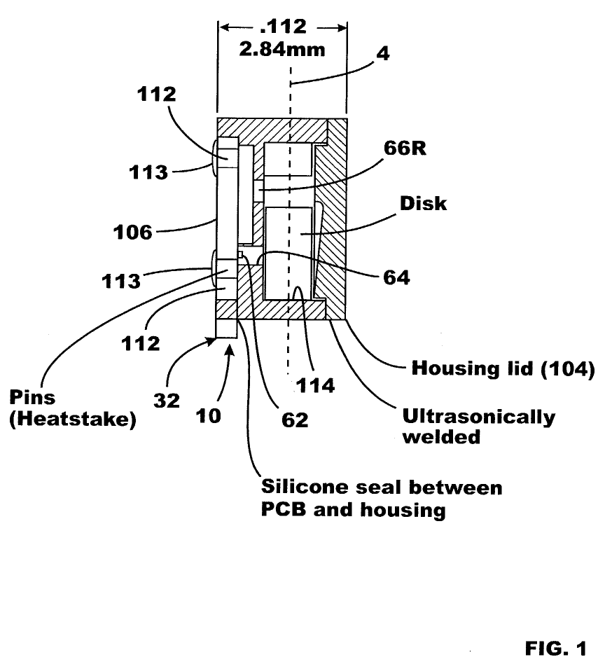

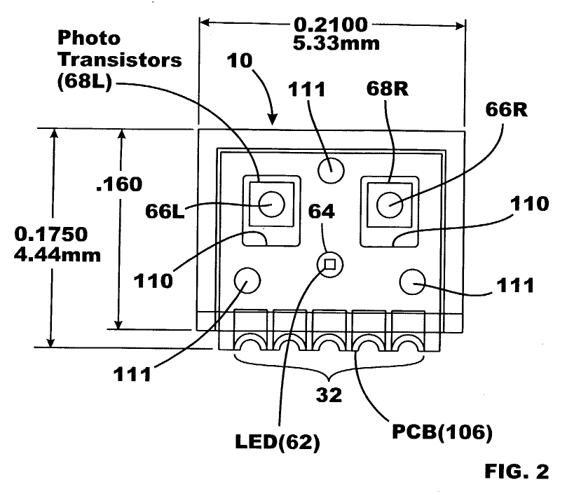

FIGS. 1-4A and 4B illustrate the basic components of a tilt sensor 10 according to the exemplary embodiment. A main housing (injected molded plastic) has a center wall 113. On one side of center wall 113 is disk cavity 114. Housing lid 104 fits over this cavity 114 to enclose it. Housing lid 104 is injected molded plastic and can be ultrasonically welded to housing 102. The other side of middle wall 113 includes cut-out 108 adapted to receive and seat printed circuit board 106. Pins 112 extend outwardly in cut out 108 to align PCB 106. The distal ends of pins 113 can be heated or expanded to lock PCB 106 in place.

A pair of photo transistors 68L and 68R can be mounted by conventional means onto PCB 106. Likewise, an electromagnetic radiation source or light source 62 (e.g. IR LED) can be mounted to PCB 106. By appropriate circuitry, each of the photo transistors and LED can be electrically connected to electrical connections 32, which are adapted for electrical connection to electrical power and inputs and outputs.

Middle wall 113 of main housing 102 includes appetures in alignment with photo transistors 68L and 68R and LED 62. As can be seen, when PCB 106 is installed into main housing 102, LED 62 is aligned with aperture 64 through middle wall 113. This provides an optical pathway from LED 62 into disk cavity 114. Similarly, when PCB 106 is installed to housing 102, photo transistors 68L and 68R are aligned with aperture 66R and 66L in middle wall 113 to allow an optical pathway between each photo transistor and disk cavity 114.

A secondary cut-out 108 can exist in middle wall 113 to provide adequate space around each photo transistor 68L and 68R when PCB 106 is installed to housing 102.

Sensor 10 therefore basically consists of a PCB 106, with the electro-optical components discussed, heat staked to housing 102, and a housing lid 104 ultrasonically welded to the other side of housing 102. Before attaching lid 104, a stamped bronze disk 60 is inserted into disk cavity 114. The welding of lid 104 to housing 102 encloses and restrains disk 60 in disk cavity 114.

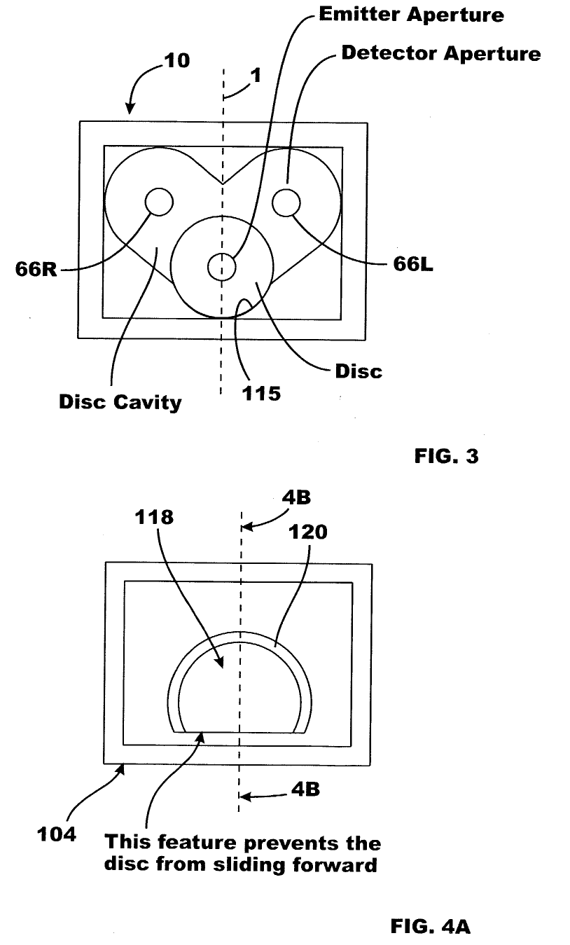

Cavity 114 is basically V-shaped (see, in particular, FIG. 3). In its default or reference position, disk 60 is seated in a semi-cylindrical trough or seat 115. Cavity 114 has two branches extending angularly in opposite directions from that default position. Aperture 64 for LED 62 is essentially centered with the center of disk 60 when disk 60 is in the position shown in FIG. 3. As can be appreciated, in this default position, light energy from LED 62 would be substantially blocked from entering cavity 114.

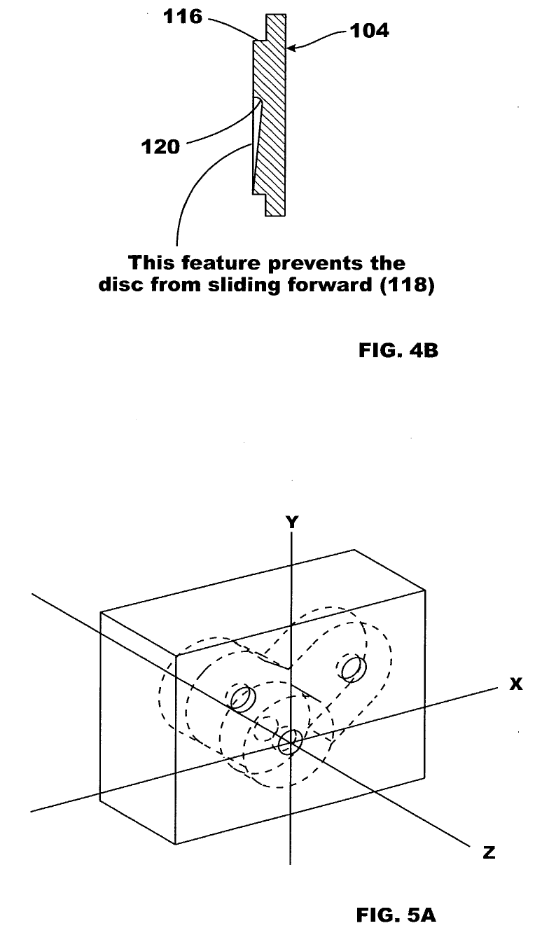

As shown in FIGS. 4A and 4B, along with FIG. 1, lid 104 includes a cut out portion 118 that is generally coincident with disk 60 when it is in the default position. Note, though, cut out 118 is asymmetrical and includes a beveled edge 120. This configuration prevents disk 60 from sliding forward.

FIGS. 1-4A and 4B illustrate exemplary dimensions for one embodiment of sensor 10. As can be seen, the diameter of disk 60 in this example is on the order of two millimeters. The outer dimensions of housing 102 are on the order of five millimeters wide, four millimeters tall, and three millimeters deep. This shows how sensor 10 can be miniaturized or micronized (micro-sized). It should be understood, however, that this configuration can be made in many different sizes, including smaller or larger versions. These particular sizes are for example only and are on the order of which are possible with many commonly commercially available electro-optical components, such as photo transistors 68L and 68R and LED 62.

The embodiment of FIGS. 1 and 4A and 4B, plastic of housing 102 and lid 104 can be of any of a variety of plastics.

B. Operation

The operation of sensor 10 is similar to that disclosed in Ser. No. 10/210,170. If housing 102 is rotated to sufficiently counterclockwise or clockwise (see FIG. 3), gravity will cause disk 60 to leave seat 115 in disk cavity 114 and move along branch of disk cavity 114 until it reaches the distal end of a branch cavity 114. Doing so would unblock aperture 64 of LED 62 and allow light into disk cavity 114. At the same time, disk 60 would block aperture 66R or 66L, as the case may be, and thus block any light from LED 62 of appreciable amount of entering the corresponding aperture to that photo transistor. But also, disk 60 would leave the other aperture 66 unblocked. Light from LED 62 entering cavity 114 would reflect off of the walls of cavity 114 and enter the aperture to the unblocked photo transistor 68. By appropriate selection of components and calibration, this would cause the unblocked photo transistor to sense the light and, with appropriate circuitry, actuate an alarm (e.g. LED light and/or sound) to indicate a tilt of housing 102 in a direction. A tilt in the opposite direction of sufficient angular amount would cause disk 60 to move in the opposite leg of cavity 114, unblock LED 62, block the photo transistor in that leg of cavity 114, and allow light from LED 62 to be detected by the photo transistor that is unblocked in the opposite leg of cavity 114. The electronic circuitry can then sense a tilt in the other direction.

The basic circuitry, and functional operation of such circuitry, is described in detail in Ser. No. 10/210,170, and therefore will not be repeated here as that disclosure is incorporated by reference herein. The major difference is utilization of disk 60 to block a single LED in the default position, and block a single photo-transistor if there is a tilt in one direction or the other, using reflectivity to trigger the other unblocked photo transistor. Therefore sensor 10 is a reflective sensor as opposed to an interrupter type described in Ser. No. 10/210,170.

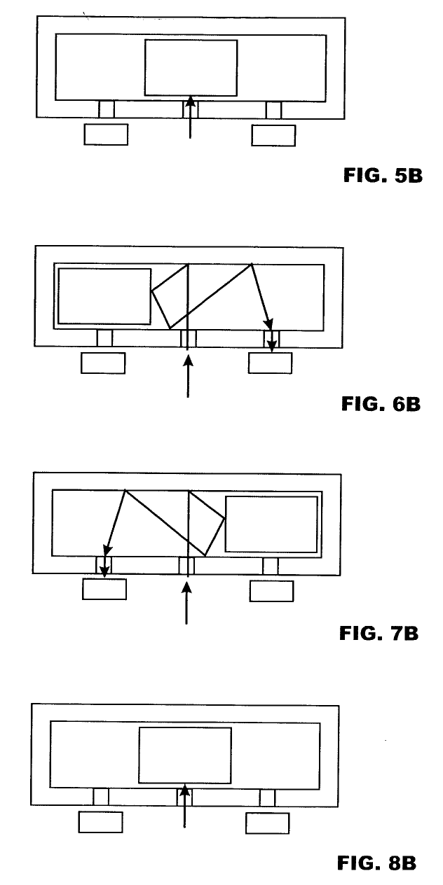

FIGS. 5A and 5B, 6A and 6B, 7A and 7B illustrate diagrammatically the three basic states of sensor 10. FIGS. 5A and 5B show a default state where disk 60 blocks LED 62 from entering cavity 114. Neither photo transistor 68L or 68R would detect light energy above a threshold to trigger them. The sensor 10 thus would indicate a default position.

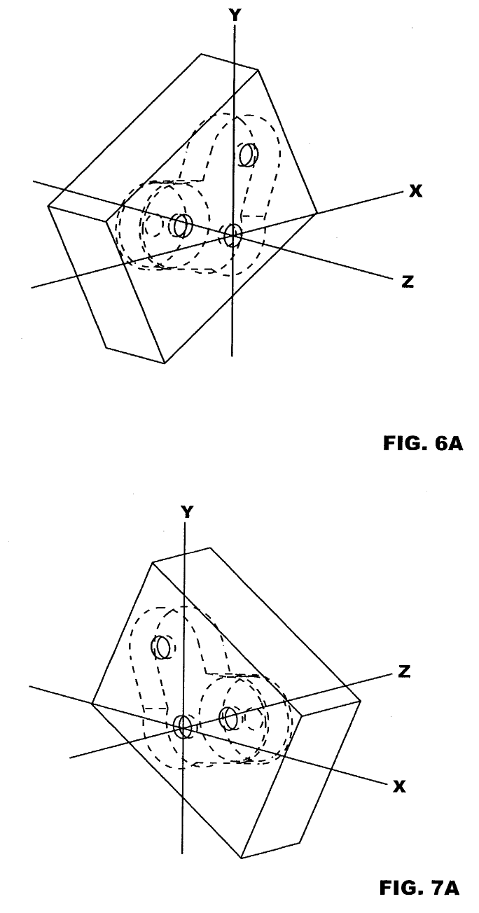

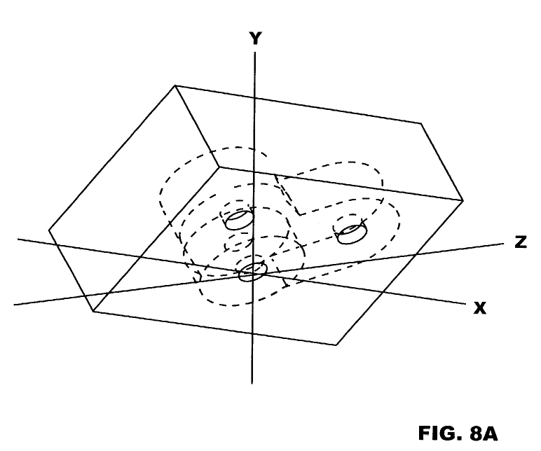

FIGS. 6A and 6B illustrate how rotation of housing 102 such that its left side rotates under horizontal a sufficient amount, causes disk 60 to roll or move to the end of leg 50L of cavity 114 blocking photo transistor 68L. Light from LED 62 entering cavity 114 would reflect from the near side of disk 60 and/or illuminate the remainder of cavity 114. Photo transistor 68R would detect this illumination and trigger.

FIGS. 7A and 7B illustrate the third state, where the right side of housing 102 is rotated under horizontal, disk 60 blocks photo transistor 68R, and photo transistor 68L triggers.

In this embodiment, some rotation around the X axis while housing 102 is generally horizontal along the X axis would not change the state of sensor 10. Disk 60 would tip forward into a symmetrical cut out 118 in lid 104 and would be prevented from sliding forward or upwardly in disk cavity 114. Disk 60 would thus be somewhat retained in its default position and thus be deterred from signaling any tilting relative to the X axis.

C. Options and Alternatives

The above described exemplary embodiment is but one form the invention can take. Variations obvious to those skilled in the art are included within the invention which is solely described by the claims.

For example, the precise configuration and dimensions of sensor 10 can vary according to desire and need. Materials can vary. In this embodiment, the materials of disk 60 and housing 102 are such that there is a relatively low coefficient of friction, meaning that disk 60 can move relatively freely in cavity 114. Like Ser. No. 10/210,170, the angular shape of cavity 114 is configured to spread approximately in either direction at 45° from the default position. Therefore, sensor 10 must be tilted at least close to 45° or more to get disk 60 to move out of its default position. However, other angular relationships are possible.

The specific electrical optical components can be selected from commercially available products with specifications according to desire and need.

The use of sensor 10 can be easily adapted to even the smaller digital cameras. Other uses and applications are, of course, possible.

The circuitry for connecting the electrical-optical components to the electrical connections 32 can be designed according to need and desire. Such design is well within the skill of those skilled in the art. It should be understood that if sensor 10 is tilted near or over 90° forwardly or backwardly relative to the Y axis, it could cause disk 60 to leave the default position. However, sensor 10 would deter, and usually disallow, movement of disk 60 out of the default position for Y axis tilting up to on the order of 90°.

The electro optical components can be die attached to a single PCB mounted to the plastic housing. Other methods of attachment of the components and the PCB are possible.

Disk 60 can be made of other materials. It basically functions as a blocking paddle.

As can be seen, in the default state (where the camera, for example, is level) disk 60 remains in its lower trough or seat 115 which is in direct alignment with the LED aperture 64. With disk 60 in the default location, the light from LED 62 is blocked from entering the interior of housing 102. At this point, no light is incident on either photo diode 68L or 68R so the output for both left and right channels are low. Once the sensor is tilted left or right, disk 60 will roll into the corresponding trough or leg 50L or 50R and block the aperture 66R or 66L centered in that leg and now occupied by disk 60. Light from LED 62 is now free to flood the interior of disk cavity 114 and is reflected off the surface of lid 104 and into the unblocked photo transistor aperture.

Whereas the invention has been shown and described in connection with the preferred embodiment thereof, it will be understood that any modifications, substitutions, and additions may be made which are within the intended broad scope of the following claims. From the foregoing, it can be seen that the present invention accomplishes at least all of the stated objectives.

What is claimed is:

1. A tilt sensor comprising:
a housing;
a cavity in the housing having a default position and a second position;
an element movably positionable within the cavity;
a light source aperture aligned with the default position of the cavity;
a photo detector aperture positioned away from the second position of the cavity;
so that the light source aperture is blocked when the element is in a default position and the light source aperture and the photo detector aperture are unblocked when the element is in the second position.

2. The tilt sensor of claim 1 wherein the element is a disk shape.

3. The tilt sensor of claim 1 wherein the cavity comprises a race for the element.

4. The tilt sensor of claim 3 wherein the race comprises two branches, each branch extending in opposite directions of the default position.

5. The tilt sensor of claim 4 wherein the branches are in angular orientation to one another.

6. The tilt sensor of claim 5 wherein the angular orientation is approximately 90°.

7. The tilt sensor of claim 1 further comprising a light source in optical communication with the light source aperture.

8. The tilt sensor of claim 7 wherein the light source is an infrared LED.

9. The tilt sensor of claim 1 further comprising a photo detector in optical communication with the photo detector aperture.

10. The tilt sensor of claim 1 wherein the photo detector comprises a photo transistor.

11. The tilt sensor of claim 4 wherein the photo detector aperture is generally positioned at or near the end of one branch of the race and a second photo detector is positioned at or near the end of the opposite branch of the race, the second photo detector aperture being coincident with the second position of the element.

12. The tilt sensor of claim 11 wherein the element blocks the LED aperture in the default position, blocks one photo detector aperture if tilted sufficiently, and unblocks the LED aperture and the other photo detector aperture.

13. The tilt sensor of claim 1 wherein the housing comprises a two-piece housing.

14. The tilt sensor of claim 13 wherein the one-piece of the housing includes a cut out adapted for reception of a printed circuit board.

15. The tilt sensor of claim 14 wherein the printed circuit board comprises a light source and a photo detector.

16. The tilt sensor of claim 13 wherein the housing further comprises a second cut out comprising the cavity.

17. The tilt sensor of claim 16 further comprising a lid positionable over the second cut out.

18. The tilt sensor of claim 13 wherein the housing is plastic.

19. The tilt sensor of claim 18 wherein the two-pieces are ultrasonically welded together.

20. The tilt sensor of claim 1 wherein the element comprises a metal disk.

21. The tilt sensor of claim 17 wherein the lid comprises a recess aligned with the default position of the cavity and adapted to receive a portion of the disk and deter sliding of the disk if the housing is tipped forwardly.

22. The tilt sensor of claim 1 wherein the housing is micro-size.

23. The tilt sensor of claim 22 wherein the perimeter dimensions of the housing are on the order of several millimeters wide, tall, and thick.

24. The tilt sensor of claim 15 wherein the printed circuit board comprises electro optical components and printed circuits of connections between the components and electrical connections.

25. The tilt sensor of claim 15 further comprising a silicone seal between the printed circuit board and the housing.
